(19) United States
(12) Patent Application Publication
(10) Pub. No.: US 2021/0069793 A1
(43) Pub. Date: Mar. 11, 2021

(54) METHOD FOR MANUFACTURING THREE-DIMENSIONAL SHAPED OBJECT

(71) Applicant: Panasonic Intellectual Property Management Co., Ltd., Osaka (JP)

(72) Inventors: Akifumi NAKAMURA, Osaka (JP); Norio YOSIDA, Nara (JP)

(73) Assignee: Panasonic Intellectual Property Management Co., Ltd., Osaka (JP)

(21) Appl. No.: 16/965,924

(22) PCT Filed: Jan. 30, 2019
(86) PCT No.: PCT/JP2019/004124

§ 371 Date: Jul. 29, 2020

(30) Foreign Application Priority Data
Jan. 31, 2018 (JP) 2018-014903

(51) Int. Cl. B22F 3/16; B22F 3/105; B29C 64/153

(52) U.S. Cl. CPC B22F 3/16; B33Y 10/00; B29C 64/153; B22F 3/1055

(57) ABSTRACT

There is provided a method for manufacturing a three-dimensional shaped object by alternate repetition of a powder-layer forming and a solidified-layer forming, including: (i) forming a solidified layer by irradiating a predetermined portion of a powder layer with a light beam, thereby allowing a sintering of the powder in the predetermined portion or a melting and subsequent solidification of the powder; and (ii) forming another solidified layer by newly forming a powder layer on the formed solidified layer, followed by an irradiation of a predetermined portion of the newly formed powder layer with the light beam. The plurality of the solidified portions of the powder layers overlap each other, and after a formation of a first solidified portion, at least both main edge regions of the first solidified portion are irradiated with the light beam.

### TECHNICAL FIELD

The disclosure relates to a method for manufacturing a three-dimensional shaped object. More particularly, the disclosure relates to a method for manufacturing a three-dimensional shaped object in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known. Such method can be generally referred to as “selective laser sintering method”. The three-dimensional shaped object can be produced in the method by an alternate repetition of a powder-layer forming and a solidified-layer forming on the basis of the following (i) and (ii):

(i) forming a solidified layer by irradiating a predetermined portion of a powder layer with a light beam, thereby allowing a sintering of a powder in the predetermined portion or a melting and subsequent solidification thereof; and

(ii) forming another solidified layer by newly forming a powder layer on the resulting solidified layer, followed by the irradiation of a predetermined portion of the powder layer with the light beam;

This kind of technology makes it possible to produce the three-dimensional shaped object with its complicated contour shape in a short period of time. The three-dimensional shaped object can be used as a mold in a case where an inorganic powder material (e.g., a metal powder material) is used as the powder material. While on the other hand, the three-dimensional shaped object can also be used as various kinds of models in a case where an organic powder material (e.g., a resin powder material) is used as the powder material.

Taking a case as an example wherein the metal powder is used as the powder material and the three-dimensional shaped object produced therefrom is used as the mold, the selective laser sintering method will now be briefly described. As shown in FIGS. 13A-13C, a powder layer 22 with its predetermined thickness is firstly formed on a base plate 21 by a movement of a squeegee blade 23 (see FIG. 13A). Then, a predetermined portion of the powder layer 22 is irradiated with a light beam L to form a solidified layer 24 (see FIG. 13B). Another powder layer is newly provided on the formed solidified layer, and is irradiated again with the light beam to form another solidified layer. In this way, the powder-layer forming and the solidified-layer forming are alternately repeated, thereby allowing the solidified layers 24 to be stacked with each other (see FIG. 13C). The alternate repetition of the powder-layer forming and the solidified-layer forming leads to a production of a three-dimensional shaped object with a plurality of the solidified layers integrally stacked. The lowermost solidified layer 24 can be provided in a state of being adhered to a surface of the base plate 21. Therefore, there can be obtained an integration of the three-dimensional shaped object and the base plate 21. The integrated three-dimensional shaped object and base plate can be used as the mold.

### PATENT DOCUMENTS (RELATED ART PATENT DOCUMENTS)

PATENT DOCUMENT 1: Japanese Unexamined Patent Application Publication No. 2002-69507

### DISCLOSURE OF THE INVENTION

In a case where a new powder layer 22′ having a predetermined thickness is formed on a solidified layer 24′ already formed with the light beam, the predetermined portion of the new powder layer 22′ is irradiated with the light beam along each of n (n: Natural number of 1 or more) scanning paths 10′ of the light beam such that the n scanning paths 10′ have a parallel configuration in a direction (see FIGS. 16A and 16B). Specifically, n-1th solidified portion 24n-1′ is formed by the light beam irradiation along n-1th scanning path 10′. Subsequently, a part of the n-1th solidified portion 24n-1′ and powders adjacent to the solidified portion 24n-1′ are irradiated with the light beam along the nth scanning path 10′. The light beam irradiation makes it possible to obtain a new solidified layer composed of a plurality of the solidified portions overlapping with each other.

The inventors of the present application have “newly” found that the following technical problem may arise in the case where the light beam-irradiation is performed along each scanning path 10′ such that the n scanning paths 10′ have a parallel configuration in a direction (see FIGS. 16A and 16B).

Specifically, a height of a first solidified portion 24a′ is larger than that of another solidified portion (e.g., a second solidified portion 24b′) secondly and subsequently formed by the light beam irradiation along a second and subsequent scanning pass 10′, the first solidified portion 24a′ being firstlty formed by the light beam irradiation along a first scanning pass 10′. This may be based on the following reason. Specifically, upon a formation of the first solidified portion 24a′, both side portions external to a light beam-irradiation region along the first scanning path 10′, the both side portions being adjacent to the light beam-irradiation region are non-irradiated regions of the light beam (i.e., portions where powder exists). Thus, an irradiation heat of the light beam may cause powders 19′ at the both side portions to be drawn or pulled into the light beam irradiation region side along the first scanning path 10′. While on the other hand, upon a light beam irradiation along the second and subsequent scanning paths 10′, the already formed solidified portion immediately close to the light beam irradiation region is located at one of side portions external to the light beam-irradiation region, the one of the side portions being adjacent to the light beam-irradiation region. Thus, the amount of powder which is drawn from the one of the side portions to the light beam irradiation region along the second scanning path 10′ by the irradiation heat of the light beam is relatively less than the amount of powder which is drawn from the other of the side portions to the irradiation region side. As a result, upon the light beam irradiation along the first scanning paths 10′ as compared with a point in time of the light beam irradiation along the second and subsequent scanning paths 10′, it is possible to draw a relatively more powders into the light beam irradiation region along the first scanning path 10′. Accordingly, as described above, the formed first solidified portion 24a′ may be relatively higher than another solidified portion secondly and subsequently formed (e.g., second solidified portion 24b′).

In a case where the first solidified portion 24a′ may be relatively higher than the second solidified portion 24b′, a horizontally movable squeegee may come into contact with the first solidified portion 24a′ (see FIG. 16c), the horizontally movable squeegee being used in a subsequent formation of a new powder layer. The contact with the first solidified portion may make a suitable formation of the new powder layer difficult. As a result, a suitable formation of a new solidified layer may be difficult, which may make it difficult to finally suitably manufacture a three-dimensional shaped object of stacked solidified layers. That is, a highly accurate three-dimensional shaped object may not be finally obtained.

The present invention has been created under these circumstances. That is, an object of the present invention is to provide a method for manufacturing a three-dimensional shaped object which is capable of more reducing a height of a first solidified portion as a solidified portion firstly formed after a formation of a predetermined powder layer.

In order to achieve the above object, an embodiment of the present invention provides a method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by newly forming a powder layer on the formed solidified layer, followed by an irradiation of a predetermined portion of the newly formed powder layer with the light beam,
wherein the solidified layer composed of a plurality of solidified portions is formed, the plurality of the solidified portions overlapping with each other, and
wherein, after a formation of a first solidified portion as a solidified portion which is firstly formed, at least both main edge regions of the first solidified portion are irradiated with the light beam.

### EFFECT OF THE INVENTION

According to the manufacturing method of the present invention, it is possible to more reduce a height of a first solidified portion as a solidified portion firstly formed after a formation of a predetermined powder layer.

### BRIEF DESCRIPTION OF THE DRAWINGS

FIG. 1 is a cross-sectional view schematically showing a technical idea of the present invention.

FIG. 2 is a cross-sectional view schematically showing a first irradiation embodiment of the present invention (i.e., an embodiment wherein two irradiation regions are passed).

FIG. 3 is a plan view schematically showing a first irradiation embodiment of the present invention (i.e., an embodiment wherein two irradiation regions are passed).

FIG. 4 is a cross-sectional view schematically showing a solidified portion formed in accordance with a conventional irradiation embodiment and a solidified portion formed in accordance with a first irradiation embodiment of the present invention, respectively.

FIG. 5A is a plan view schematically showing a solidified portion formed in accordance with a conventional irradiation embodiment.

FIG. 5B is a plan view schematically showing a solidified portion formed in accordance with a first irradiation embodiment of the present invention.

FIG. 6 is a plan view schematically showing an embodiment wherein light beams having energy densities different from each other are used.

FIG. 7 is a plan view schematically showing a second irradiation embodiment of the present invention (i.e., an embodiment wherein a single irradiation region is passed).

FIG. 8 is a plan view schematically showing a more preferred second irradiation embodiment of the present invention.

FIG. 9 is a plan view schematically showing a more preferred second irradiation embodiment of the present invention.

FIG. 10 is a plan view schematically showing an embodiment wherein a first solidified portion is formed using a virtual contour as a standard, the virtual contour being to be a contour of the solidified layer.

FIGS. 11A-11C are cross-sectional photographs on a comparative example.

FIGS. 11D-11F are cross-sectional photographs on a working example.

FIGS. 12A-12C are top plan photographs on a comparative example.

FIGS. 12D-12F are top plan photographs on a working example.

FIG. 13A is a cross-sectional view schematically showing a laser-sintering/machining hybrid process upon a formation of a powder layer in accordance with the selective laser sintering method.

FIG. 13B is a cross-sectional view schematically showing a laser-sintering/machining hybrid process upon a solidified layer in accordance with the selective laser sintering method.

FIG. 13C is a cross-sectional view schematically showing a laser-sintering/machining hybrid process in a process of a stack in accordance with the selective laser sintering method.

FIG. 14 is a perspective view schematically showing a construction of a laser-sintering/machining hybrid machine.

FIG. 15 is a flow chart of general operations of a laser-sintering/machining hybrid machine.

FIG. 16A is a top plan view schematically showing an embodiment wherein a light beam irradiation is performed along each scanning path, the embodiment relating to a technical problem of the present application.

FIG. 16B is a cross-sectional view schematically showing an embodiment wherein a light beam irradiation is performed along each scanning path, the embodiment relating to a technical problem of the present application.

FIG. 16C is a cross-sectional view schematically showing an embodiment wherein a new powder layer is formed using a squeezing blade, the embodiment relating to a technical problem of the present application.

### MODES FOR CARRYING OUT THE INVENTION

An embodiment of the present invention will be described in more detail with reference to the accompanying drawings. It should be noted that a configuration and a dimension of composition elements in the drawings are merely for illustrative purposes, and thus not the same as those of the actual composition elements.

The term “powder layer” as used herein means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The term “upward/downward” direction directly or indirectly as used herein corresponds to a direction based on a positional relationship between a base plate and a three-dimensional shaped object. Aside for manufacturing the three-dimensional shaped object is defined as the “upward direction”, and a side opposed thereto is defined as the “downward direction” using a position at which the base plate is provided as a standard.

### Selective Laser Sintering Method

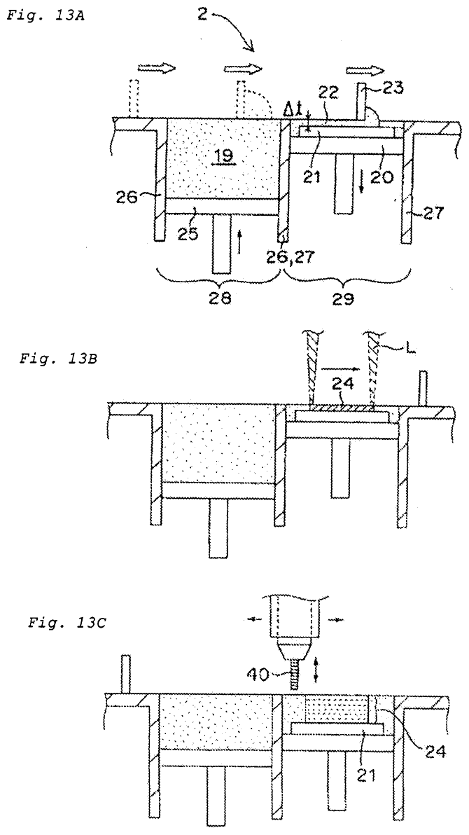

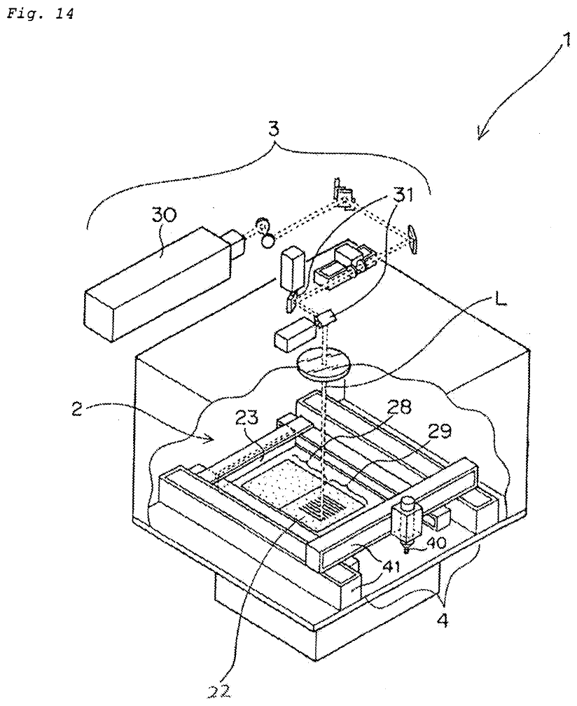

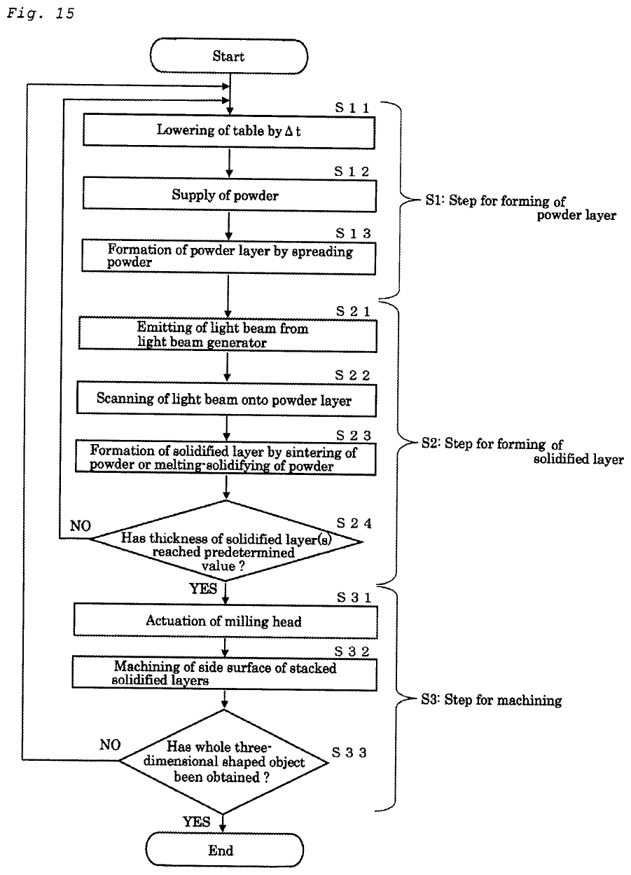

First of all, a selective laser sintering method, on which the manufacturing method according to an embodiment of the present invention is based, will be described. By way of example, a laser-sintering/machining hybrid process wherein a machining is additionally carried out in the selective laser sintering method will be explained. Each of FIGS. 13A-13C schematically shows a process embodiment of the laser-sintering/machining hybrid. FIGS. 14 and 15 respectively show major constructions and operation flow regarding a metal laser sintering hybrid milling machine for enabling an execution of a machining process as well as the selective laser sintering method.

As shown in FIG. 14, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder). The light-beam irradiator 3 is a means for irradiating a predetermined portion of the powder layer with a light beam “L”. The machining means 4 is a means for milling a surface of stacked solidified layers, i.e., a surface of a three-dimensional shaped object.

As shown in FIGS. 13A-13C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20 to thereby form a powder layer 22. The forming table 20 is a table capable of vertically elevating/descending in a forming tank 29 whose outer periphery is surrounded with a wall 27. The base plate 21 is disposed on the forming table 20 and serves as a platform of the three-dimensional shaped object.

As shown in FIG. 14, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 14, the machining means 4 is mainly composed of a milling head 40 and an actuator 41. The milling head 40 is a cutting tool for milling the surface of the stacked solidified layers, i.e., the surface of the three-dimensional shaped object. The actuator 41 is a means for driving the milling head 40 to move toward the position to be milled.

Operations of the laser sintering hybrid milling machine 1 will now be described in detail. As can been seen from the flowchart of FIG. 15, the operations of the laser sintering hybrid milling machine are mainly composed of a powder layer forming step (S1), a solidified layer forming step (S2), and a machining step (S3). The powder layer forming step (S1) is a step for forming the powder layer 22. In the powder layer forming step (S1), the forming table 20 is firstly descended by Δt (S11) to thereby create a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 13A. This enables a powder 19 placed on the powder table 25 to be spread onto the base plate 21 (S12) while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 13B. Examples of the light beam “L” include carbon dioxide gas laser, Nd:YAG laser, fiber laser, ultraviolet light and the like.

The powder layer forming step (S1) and the solidified layer forming step (S2) are alternately repeated. This allows a plurality of the solidified layers 24 to be integrally stacked with each other as shown in FIG. 13C.

When a thickness of the stacked solidified layers 24 reaches a predetermined value (S24), the machining step (S3) is started. The machining step (S3) is a step for milling the surface of the stacked solidified layers 24, i.e., the surface of the three-dimensional shaped object. The milling head 40 (see FIG. 13C and FIG. 14) is actuated to start an execution of the machining step (S31). For example, in a case where the milling head 40 has an effective milling length of 3 mm, a machining can be performed with a milling depth of 3 mm in a height direction of the three-dimensional shaped object. Therefore, supposing that “Δt” is 0.05 mm, the milling head 40 is actuated when a formation of sixty solidified layers 24 is completed. Specifically, the surface of the stacked solidified layers 24 is subjected to the machining process (S32) through a movement of the milling head 40 driven by the actuator 41. Subsequent to the surface machining step (S3), it is judged whether or not a desired three-dimensional shaped object has been obtained (S33). When the desired three-dimensional shaped object has not yet been obtained, the step returns to the powder layer forming step (S1). Thereafter, the steps S1 through S3 are repeatedly performed again for a further stacking of the solidified layers 24 and a further machining process, which eventually leads to a provision of the desired three-dimensional shaped object.

### Manufacturing Method of the Present Invention

A manufacturing method according to an embodiment of the present invention is characterized by features associated with an embodiment wherein a predetermined portion of the powder layer is irradiated with the light beam in the selective laser sintering method as described above.

### Technical Idea of the Present Invention

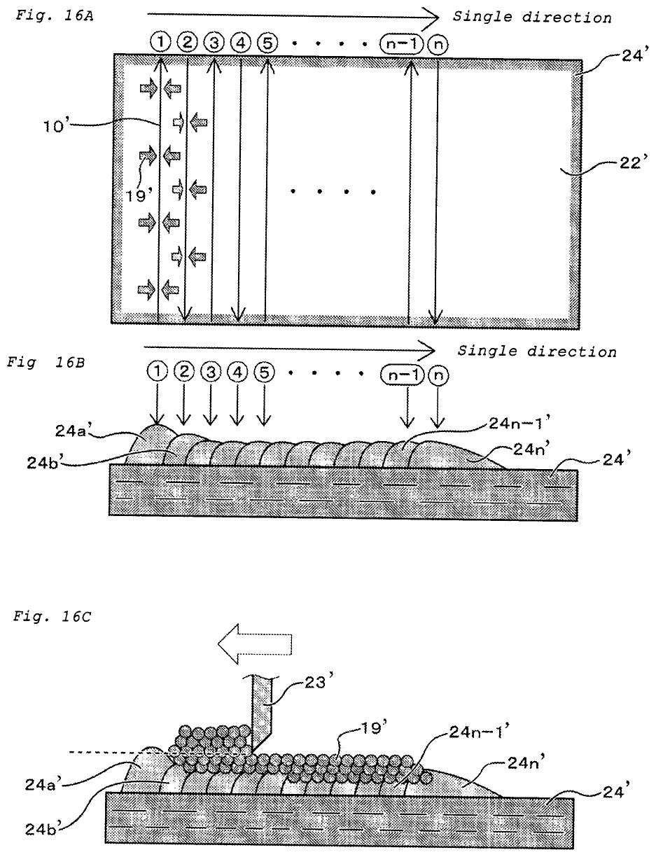

As described above, the inventors of the present application have newly found that the following technical problem may arise in a case where a light beam-irradiation is performed along each of scanning paths 10′ such that the scanning paths 10′ have a parallel configuration in a direction (see FIGS. 16A and 16B). Specifically, a height of a first solidified portion 24a′ as a solidified portion which is firstlty formed may be larger than that of another solidified portion (e.g., a second solidified portion 24b′) secondly and subsequently formed by the light beam irradiation. In light of the above matters, the inventors of the present invention have diligently considered a technical solution for further reducing a height of the first solidified portion 24a′.

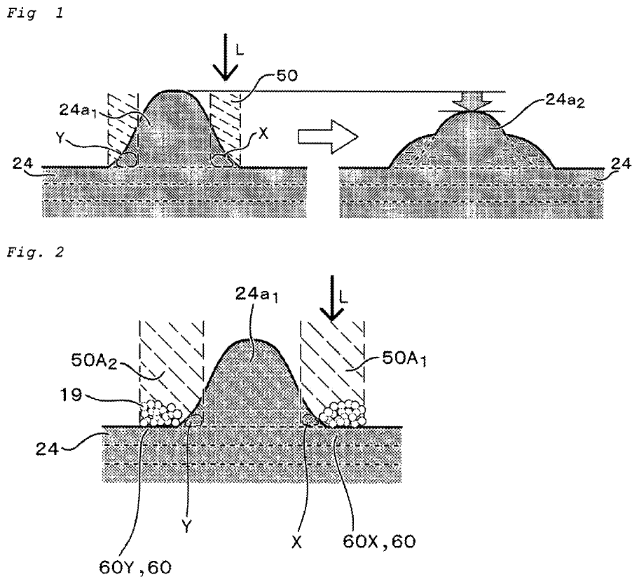

As a result of the consideration, the inventors of the present application have created the technical solution by a way that the skilled person does not normally conduct according to a technical common knowledge of the skilled person (i.e. an embodiment wherein the light beam-irradiation is performed along each of the scanning paths 10′ such that the scanning paths 10′ have a parallel configuration in a direction). Specifically, the inventors of the present application have created the present invention having such a technical idea that, after a formation of a first solidified portion 24a₁ as a solidified portion which is firstly formed, at least both main edge regions X, Y of the first solidified portion 24a₁ are irradiated with the light beam L (see a left side portion of FIG. 1). According to the technical idea of the present invention, at least both main edge regions X, Y of the first solidified portion 24a₁ are irradiated with the light beam L. Namely, at least both of “the one of the main edge regions X of the first solidified portion 24a₁” and “the other of the main edge regions Y thereof” are irradiated with the light beam L.

As described above, according to the technical common knowledge of the skilled person, it is general that the light beam-irradiation is performed along each of the scanning paths 10′ such that the scanning paths 10′ have the parallel configuration in a direction in terms of a scanning efficiency and an use efficiency of the light beam. That is, it is general that a plurality of scanning paths of the light beam are arranged in parallel in a direction. While on the other hand, according to the technical idea of the present invention different from a conventional technical common knowledge of the skilled person, after the first solidified portion 24a₁ is temporarily formed, other of the main edge regions Y of the temporarily formed first solidified portion 24a₁ as well as one of the main edge regions X thereof is “consciously” irradiated with the light beam L”, the other of the main edge regions Y being located on an opposite side of the one of the main edge regions X. A point on which the present invention focuses is a futher reduction in a height of the first solidified portion 24a′. As a result, the other of the main edge regions Y of the first solidified portion 24a₁ is also irradiated with the light beam L according to an embodiment of the present invention. This is the most characteristic point of the present invention not existing in the conventional technical common knowledge of the skilled person.

The phrase “main edge region” as used herein means an edge region on a longitudinal side of a solidified portion (e.g., a first solidified portion or the like) extending in an axial direction in a broad sense. The phrase “main edge region” as used herein means a region from a linear contour on a longitudinal side of the temporarily formed solidified portion (e.g., first solidified portion or the like) to an inside portion by a “predetermined width” in a narrow sense. While not being particularly limited, the predetermined width is a width of about 3% to about 30%, preferably about 6% to about 20%, for example about 10% of a width of a bottom portion of the temporarily formed first solidified portion. Namely, it should be noted that the “main edge region” as used herein does not correspond to the linear contour on the longitudinal side of the first solidified portion. The phrase “after a formation of a first solidified portion, at least both main edge regions of the first solidified portion are irradiated with the light beam” means that at least the one of the main edge regions of the first solidified portion is irradiated with the light beam shortly after the first solidified portion has been temporarily formed, and subsequently at least the other of the main edge regions of the first solidified portion is irradiated with the light beam. This means that the above phrase may include an embodiment wherein the other of the main edge regions of the first solidified portion is irradiated with the light beam after a light beam-irradiation has been performed along each of scanning paths such that the scanning paths have a parallel configuration in a direction (e.g., after a formation of a fourth solidified portion, a fifth solidified portion, a sixth solidified portion and the like). The phrase “scanning path of the light beam” as used herein means a movement path of the light beam.

When at least both main edge regions X, Y of the first solidified portion 24a₁ are irradiated with the light beam after the first solidified portion 24a₁ is temporarily formed, due to a movement of the light beam L along its scanning path, light beam irradiation regions 50 are passed through at least both main edge regions X, Y of the first solidified portion 24a₁ (see left side portion in FIG. 1). The phrase “light beam irradiation region” as used herein means a region having a width where a predetermined region (i.e., main edge region and the like) of the first solidified portion is irradiated with the light beam along its scanning path. That is, both main edge regions X, Y of the first solidified portion 24a₁ may be suitably positioned in the light beam irradiation region 50 in a plan view. Thus, an irradiation heat of the light beam L can be suitably transferred to both main edge regions X, Y which have been temporarily in a solidified state, which enables the both main edge regions X, Y to be changed from a solidified state to a melted state. Furthermore, the first solidified portion 24a₁ may be formed by causing powders at both side portions external to the light beam irradiation region to be drawn into the light beam irradiation region, the light beam irradiation region being formed along the first scanning path. Since the powders are drawn from the both side portions into the light beam irradiation region, the first solidified portion 24a₁ may be a raised portion having an inclined surface in a cross-sectional view. As a result, when both main edge regions X, Y are changed from the solidified state to the melted state, due to the fact that the melted both main edge regions X, Y have a fluidity and the first solidified portion 24a₁ has the inclined cross sectional surface, at least a part of each of the melted both main edge regions X, Y may flow outwardly in a cross-sectional view (see right side portion of FIG. 1). Specifically, a melted portion of each main edge region X, Y may flow to a non-irradiated region of the light beam such that, due to a wettability of the melted portion, the melted portion may spread to the non-irradiated region, the non-irradiated region being located outside the first solidified portion 24a₁ in a cross-sectional view.

Due to the outward-flow of the melted portion, it is possible to further reduce a height (specifically, a height of a top region or zenith region) of a first solidified portion 24a₂ which is newly obtained by a re-solidification of the melted portion after the irradiation of the both main edge regions X, Y with the light beam, compared with a height of the first solidified portion 24a₁ at a point in time before the irradiation of the both main edge regions X, Y with the light beam L. That is, it is possible to form the first solidified portion 24a₂ with a further reduced height (see right side portion in FIG. 1), which enables the obtained first solidified portion 24a₂ with the further reduced height to be positioned below a lower end of a horizontally movable squeezing blade to be used later for a formation of a new powder layer. Thus, it is possible to suitaly prevent a contact of the horizontally movable squeegee blade for the formation of the new powder layer with the first solidified portion 24a₂. The prevention of the contact enables the subsequent new powder layer to be suitably formed. As a result, a subsequent new solidified layer can be suitably formed. Accordingly, it is finally possible to suitaly obtain a highly accurate three-dimensional shaped object.

There may be the following two irradiation embodiments as embodiments wherein the both main edge regions X, Y of the first solidified portion 24a₁ are irradiated with the light beam L.

### First Irradiation Embodiment

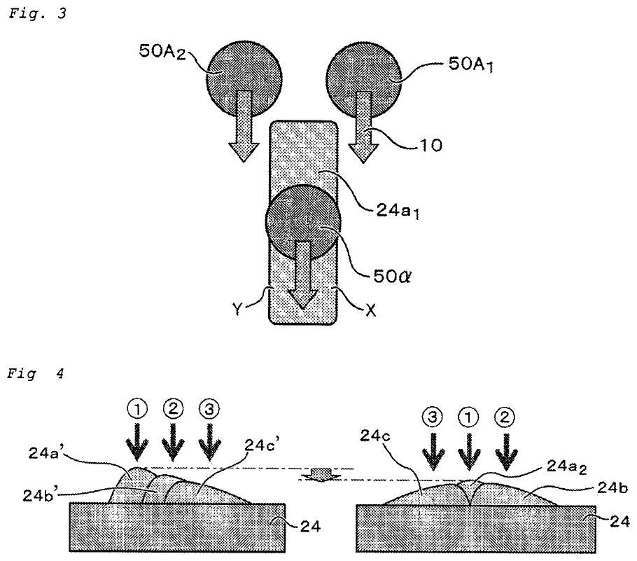

A first irradiation embodiment is an embodiment wherein at least both main edge regions X, Y and non-irradiated regions 60 are irradiated with the light beam L, the non-irradiated regions 60 being respectively adjacent to the both main edge regions X, Y (see FIGS. 2 and 3).

According to the first irradiation embodiment, at least the both main edge regions X, Y and the non-irradiated regions 60 are irradiated with the light beam L, the non-irradiated regions 60 being respectively adjacent to the both main edge regions X, Y. Specifically, according to the first irradiation embodiment, one of the main edge regions X and the non-irradiated region 60 adjacent to the one of the main edge regions X are irradiated with the light beam L. In addition, according to the first irradiation embodiment, other of the main edge regions Y and the non-irradiated region 60 adjacent to the other of the main edge regions Y are irradiated with the light beam L.

More specifically, an irradiation region 50α of a light beam L along a scanning path 10 is passed through a predetermined portion of the powder layer to thereby form a first solidified portion 24a₁. After the formation of the first solidified portion 24a₁, one of main edge regions X thereof and a non-irradiated region 60X adjacent to the one of the main edge regions X are irradiated with the light beam L. In this case, a movement of the light beam L along a scanning path enables an irradiation region 50A₁ of the light beam L to be passed through the one of the main edge regions X of the first solidified portion 24a₁ and the non-irradiation region 60X of the light beam L (See FIG. 2). That is, the one of the main edge regions X of the first solidified portion 24a₁ and the non-irradiated region 60X of the light beam L are suitably positioned in the irradiation region 50A₁ of the light beam L in a plan view. Thus, an irradiation heat of the light beam L may be suitably provided or transferred to the one of the main edge regions X which has been temporarily in a solidified state and powders 19 in the non-irradiated region 60X. As a result, this may cause both of the one of the main edge regions X which has been temporarily in the solidified state and the powders 19 in the non-irradiated region 60X to be in a melted state.

When the one of the main edge regions X is changed from the solidified state to the melted state, due to the fact that the melted one of the main edge regions X has a fluidity and the first solidified portion 24a₁ has an inclined cross sectional surface, at least a part of the melted one of the main edge regions X may flow outwardly in a cross-sectional view. This enables at least a part of melted portion of the one of the main edge regions X flowing ourwardly and a melted portion of the powders 19 in the non-irradiated region 60X to be mixed with each other.

Furthermore, after the formation of the first solidified portion 24a₁, other of main edge regions Y thereof and a non-irradiated region 60Y adjacent to the other of the main edge regions Y are irradiated with the light beam L. In this case, a movement of the light beam L along a scanning path enables an irradiation region 50A₂ of the light beam L to be passed through the other of the main edge regions Y of the first solidified portion 24a₁ and the non-irradiation region 60Y of the light beam L (See FIGS. 2 and 3). That is, the other of the main edge regions Y of the first solidified portion 24a₁ and the non-irradiated region 60Y of the light beam L are suitably positioned in the irradiation region 50A₂ of the light beam L in a plan view. Thus, an irradiation heat of the light beam L may be suitably provided or transferred to the other of the main edge regions Y which has been temporarily in a solidified state and powders 19 in the non-irradiated region 60Y. As a result, this may cause both of the other of the main edge regions Y which has been temporarily in the solidified state and the powders 19 in the non-irradiated region 60Y to be in a melted state.

When the other of the main edge regions Y is changed from the solidified state to the melted state, due to the fact that the melted other of the main edge regions Y has a fluidity and the first solidified portion 24a₁ has an inclined cross sectional surface, at least a part of the melted other of the main edge regions Y may flow outwardly in a cross-sectional view. This enables at least a part of melted portion of the other of the main edge regions Y flowing ourwardly and a melted portion of the powders 19 in the non-irradiated region 60Y to be mixed with each other.

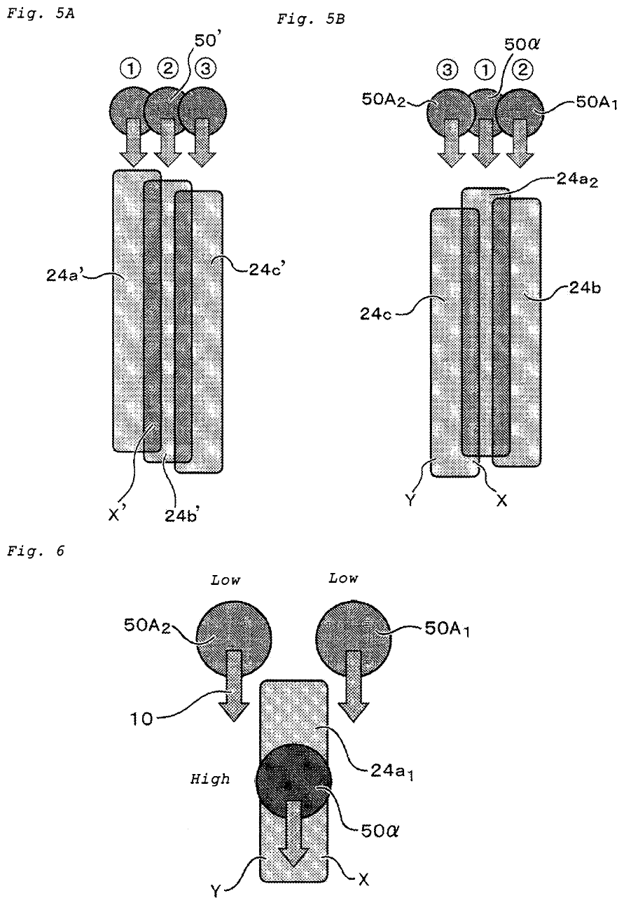

According to an embodiment based on the conventional technical common knowledge of the skilled person (i.e., an embodiment wherein scanning paths of the light beam have a parallel configuration in a direction), an irradiation region 50′ is passed through only one of main edge regions X′ of the first solidified portion which has been temporarily formed, which causes only at least a part of a melted one of the main edge regions X′ to flow outwardly. While on the other hand, an embodiment of the present invention differs from the embodiment based on the conventional technical common knowledge of the skilled person, and the both of the main edge regions X, Y is “consciously” irradiated with the light beam. Thus, not only a melted portion of the one of the main edge regions X but also a melted portion of the other of the main edge regions Y may flow outwardly. The outward-flow of the melted portion of the other of the main edge regions Y makes it possible to further reduce a height of a first solidified portion 24a₂ which is newly obtained by a re-solidification after the light beam L irradiation (see right side portion of FIG. 4 and FIG. 5B), compared with a height of a first solidified portion 24a′ obtained in the conventional embodiment (see left side portion of FIG. 4 and FIG. 5A).

Furthermore, as described above, this embodiment enables at least a part of the melted portion of each of the both main edge regions X, Y flowing ourwardly and the melted portion of the powders 19 in each of the non-irradiated regions 60X, 60Y to be mixed with each other, the non-irradiated regions 60X, 60Y being respectively adjacent to the both main edge regions X, Y. When the melted portions in the mixed state are cooled and subsequently solidified at a later time, it is possible to respectively form a second solidified portion 24b and a third solidified portion 24c on both sides of the first solidified portion having “its height already more reduced”, the second solidified portion 24b and the third solidified portion 24c overlapping with the first solidified portion. While on the other hand, according to an embodiment based on the conventional technical common knowledge of the skilled person, the light beam-irradiation is performed such that the scanning paths have the parallel configuration in a direction. The conventional light beam-irradiation contributes to a formation of a second solidified portion 24a′ overlapping with one of sides of a “relatively higher” first solidified portion 24a′, followed by a formation of a third solidified portion overlapping with one of sides of the second solidified portion 24b′.

According to this embodiment as described above, the second solidified portion 24b does not overlap with the third solidified portion 24c. The second solidified portion 24b and the third solidified portion 24c are located such that they are opposed to each other across the first solidified portion 24a. According to this embodiment, the formation of third solidified portion 24c results from the irradiation of other of both main edge regions of the first solidified portion 24a with the light beam. This means that the light beam irradiation cannot performed in sequence such that the scanning paths have the parallel configuration in a direction in accordance with the conventional technical common knowledge of the skilled person, which may lead to a reduction in the scanning efficiency and use efficiency of the light beam. Thus, for the reduction in the scanning efficiency and use efficiency of the light beam, such the embodiment “wherein the second solidified portion 24b and the third solidified portion 24c are located such that they are opposed to each other across the first solidified portion 24a” is an exceptional embodiment in light of the technical common knowledge of the skilled person. In this respect, the first embodiment has a further technical feature.

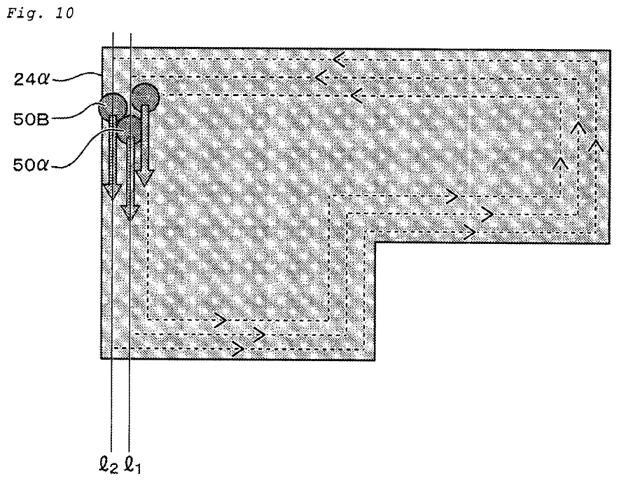

Furthermore, it is preferable to form a first solidified portion 24a₁ as follows using a virtual contour 24α to be a contour of the solidified layer as a standard (see FIG. 10). The phrase “virtual contour to be a contour of the solidified layer” substantially means a portion corresponding to a contour of the solidified layer to be formed at a later time in a predetermined portion of the powder layer which is irradiated with the light beam. Specifically, it is preferable that a scanning center line l₂ of the light beam with which one of the main edge regions of the first solidified portion 24a₁ is irradiated after the formation of the first solidified portion 24a₁ is located at a portion proximal to a virtual contour 24α, than a scanning center line l₁ of the light beam which is used when forming the first solidified portion 24a₁. In other words, the scanning center line l₂ of the light beam is positioned between the scanning center line l₁ of the light beam upon the formation of the first solidified portion 24a₁ and the virtual contour 24α. The position of the scanning center line l₂ makes it possible to reduce a height of the first solidified portion having a relatively higher ridge composing the contour portion when forming the contour portion of the solidified layer. Thus, it is possible to prevent the contour portion of the solidified layer from becoming higher than other portions other than the contour portion.

This embodiment is an embodiment wherein two irradiation regions 50A₁, 50A₂ are respectively passed through at least both main edge regions X, Y of the first solidified portion 24a₁. Specifically, the two irradiation regions 50A₁, 50A₂ are respectively passed through the at least both main edge regions X, Y of the first solidified portion 24a₁ in parallel temporally (see FIG. 3).

In a case of an use of two irradiation regions 50A₁, 50A₂, it is usual that two irradiation regions 50A₁, 50A₂ are sequentially passed through the both main edge regions X, Y of the first solidified portion 24a₁. Without being limited to this, the two irradiation regions 50A₁, 50A₂ may be passed through them in parallel temporally as described above. In this case, at least both main edge regions X, Y of the first solidified portion 24a₁ may be irradiated with the light beams having the two irradiation regions 50A₁, 50A₂ respectively at substantially the same timing. This makes it possible to eliminate a time interval between a passage timing of the one of the irradiation regions 50A₁ to the one of the main edge regions X and that of the other of the irradiation regions 50A₂ to the other of the main edge regions Y. Thus, it is possible to reduce or eliminate a difference between a melting timing of the one of the main edge regions X at a point in time when the one of the irradiation regions 50A₁ is passed through the region X and that of the other of the main edge regions Y at a point in time when the other of the irradiation regions 50A₂ is passed through the region Y. Thus, a flow-timing outwardly of the melted portion of the one of the main edge regions X can be substantially same as a flow-timing outwardly of the melted portion of the other of the main edge regions Y. Accordingly, the fact that both flow-timings are substantially the same as each other makes it possible to reduce a height of a first solidified portion 24a₂ which is newly obtained by the light beam irradiation followed by the re-solidification of the melted portion.

According to an embodiment, it is preferable that an energy density of the light beam L with which the at least both main edge regions X, Y of the first solidified portion 24a₁ are irradiated after the first solidified portion 24a₁ was temporarily formed is smaller than that of the light beam L used when forming the first solidified portion 24a₁ (see FIGS. 2 and 6).

As described above, the height of the first solidified portion 24a′ may be relatively larger than the height of the second and subsequent solidified portion (e.g., the second solidified portion 24b′) (see FIG. 16). This is due to the fact that the more powders are drawn to the light beam irradiation region in a case of the first light beam-irradiation along the first scanning path 10′, compared with a case of the second and subsequent light beam-irradiation along the second and subsequent scanning path 10′. In light of the above matters, for a more reduction in a height of the first solidified portion 24a₁ itself which is temporarily formed, it is preferable to melt the powders which are more drawn to the light beam irradiation region 50α along the first scanning path 10, thereby improving a wettability of the melted portion to a base portion located below the melted portion (e.g., already formed solidified layer or the like). Thus, it is preferable that the light beam L which is used when forming the first solidified portion 24a₁ has a relatively larger energy density.

While on the other hand, when a plurality of light beams L having a higher energy density are used to form each of solidified portions overlapping with each other, it is possible to easily melt powders which are drawn to each of light beam irradiation region, whereas due to a change from a more melted state by a higher melt level to a solidified state, a solidified layer composed of solidified portions which can be obtained may have a relatively larger shrinkage stress. As a result, a three-dimensional shaped object finally obtained may be warped. In light of the above matters, it is preferable to refrain from using the light beam L having a larger energy density as much as possible. Thus, it is preferable that the light beam L having a larger energy density is used only when forming the first solidified portion 24a having a height level larger than the second and subsequent solidified portions.

While on the other hand, upon a formation of the second and subsequent solidified portions, it is preferable to use the light beam L having an energy density relatively lower than that of the light beam L used for forming the first solidified portion 24a. As described above, according to an embodiment of the present invention, the formation of the second and subsequent solidified portions, specifically the formation of the second solidified portion 24b and the third solidified portion 24c results from the irradiation of the both main edge regions X, Y in the solidified state and the non-irradiated regions 60X, 60Y with the light beam, the non-irradiated regions 60X, 60Y being respectively adjacent to the both main edge regions X, Y. In light of the above matters, it is preferable that the both main edge regions X, Y in the solidified state and the non-irradiated regions 60X, 60Y are irradiated with the light beam having a relatively lower energy density. That is, it is preferable that at least both main edge regions X, Y is irradiated with the light beam having the relatively lower energy density.

As described above, upon the formation of the second and subsequent solidified portions, it is possible to use the light beam L having the energy density relatively lower than that of the light beam L used for forming the first solidified portion 24a. Thus, a difference in the energy density can be provided between the light beam L used upon the formation of the first solidified portion 24a and the light beam L used upon the formation of the second and subsequent solidified portions. According to an embodiment, the energy density of the light beam L used upon the formation of the second and subsequent solidified portions can be configured to be a normal level, whereas the energy density of the light beam L used upon the formation of the first solidified portion can be configured to be higher than the energy density having the normal level. The difference in the energy density of the light beam is not based on only the above embodiment. For example, according to another embodiment, the energy density of the light beam L used upon the formation of the first solidified portions can be configured to be a normal level, whereas the energy density of the light beam L used upon the formation of the second and subsequent solidified portions can be configured to be lower than the energy density having the normal level. Thus, a difference in the energy density can be also provided between the light beam L used upon the formation of the first solidified portion 24a and the light beam L used upon the formation of the second and subsequent solidified portions (e.g., the second and third solidified portions).

As can be understood from the above matters, the use of the light beam L having the relatively larger energy density makes it possible to reduce the height itself of the first solidified portion 24a₁ which is temporarily formed. A height of a newly obtained first solidified portion 24a₂ can be much more reduced due to the reduction in the height itself of the first solidified portion 24a₁ temporarily formed as well as the irradiation of the both main edge regions X, Y with the light beam after the formation of the first solidified portion 24a₁. While on the other hand, upon the formation of the second and subsequent solidified portions, the light beam having the relatively lower energy density can be used. Namely, the light beam having the relatively larger energy density, which may cause the formation of the solidified layer, specifically the solidified portion having a relatively larger shrinkage stress, is used for the formation of only the first solidified portion 24a₁ temporarily formed, whereas it is not used for the formation of the second and subsequent solidified portions. As a result, the number of the solidified layers, specifically the number of solidified portions having the relatively larger shrinkage stress can be reduced, which makes it possible to suitably prevent an occurence of a warpage of a three-dimensional shaped object to be finally obtained.

### Second Irradiation Embodiment

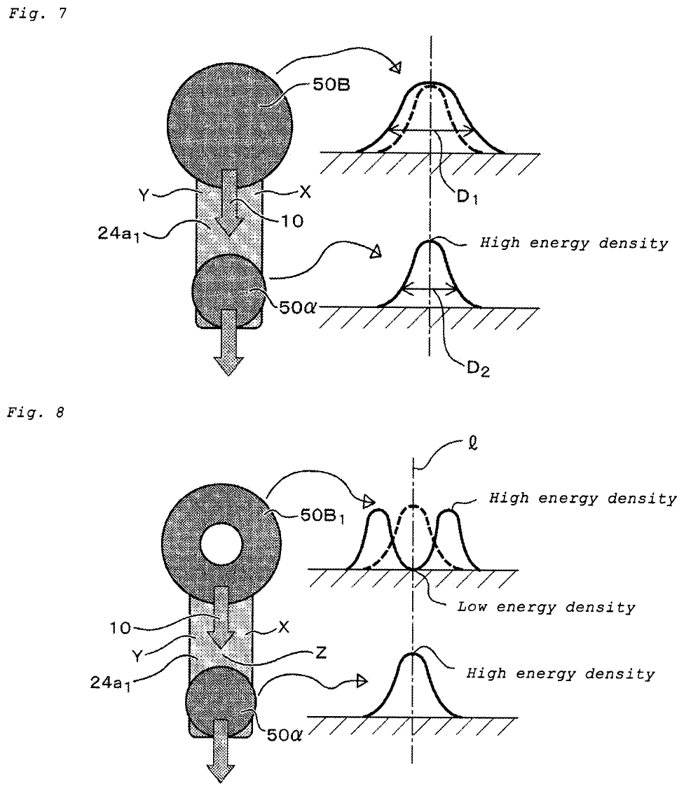

A second irradiation embodiment is an embodiment wherein, after a formation of a first solidified portion 24a₁, a light beam-irradiation is performed such that a single irradiation region 50B is passed through at least both main edge regions X, Y of the first solidified portion 24a₁ in an axial direction of the first solidified portion 24a₁ (see FIG. 7).

As described above, the present invention has the main technical idea that, subsequent to the formation of the first solidified portion 24a₁, at least both main edge regions X, Y of the first solidified portion 24a₁ are irradiated with the light beam. According to the first irradiation embodiment, two irradiation regions 50A₁, 50A₂ are used for the technical idea of the present invention. However, an embodiment for achieving the technical idea of the present invention is not limited to the first embodiment. Only a single irradiation region 50B can be used for the technical idea of the present invention. Specifically, the light beam-irradiation can be performed such that the single irradiation region 50B is passed through at least both main edge regions X, Y of the first solidified portion 24a₁ in the axial direction of the first solidified portion 24a₁.

According to the second embodiment, the single irradiation region 50B is passed through the first solidified portion 24a₁ such that the single irradiation region 50B covers an entire region of the first solidified portion 24a₁ which has been temporarily formed in a plan view. Thus, both main edge regions X, Y of the first solidified portion 24a₁ can be positioned in the light beam L-irradiation region 50B in a plan view. This enables an irradiation heat of the light beam L to be suitably transferred to an entire region including the both main edge regions X, Y and also which has been temporarily in the solidified state, which enables the entire region to be changed from the solidified state to a melted state. Thus, the both main edge regions X, Y in the entire region of the first solidified portion 24a₁ can be melted, and thus a melted portion of each main edge region X, Y may flow to a non-irradiated region of the light beam such that, due to a wettability of the melted portion, the melted portion may spread to the non-irradiated region, the non-irradiated region being located outside the first solidified portion 24a₁ in a cross-sectional view (see FIG. 2). Due to the outward-flow of the melted portion, it is possible to further reduce a height of a first solidified portion 24a₂ which is newly obtained by a re-solidification of the melted portion after the irradiation of the both main edge regions X, Y with the light beam, compared with a height of the first solidified portion 24a₁ at a point in time before the irradiation of the both main edge regions X, Y with the light beam L. Furthermore, as describe above, according to the second embodiment, the single irradiation region 50B is passed through the first solidified portion 24a₁ such that the single irradiation region 50B covers the entire region of the first solidified portion 24a₁ which has been temporarily formed in the plan view. Thus, it is possible to simplify a condition for adjusting a passing-position of the irradiation region, as compared with such the condition in the case where the two irradiation regions 50B are passed through at least both main edge regions of the first solidified portion 24a₁. That is, the second embodiment can make an adjustment for passing-position of the irradiation region easier than the first irradiation embodiment. In this respect, the second embodiment has an advantageous technical feature.

Furthermore, according to the second embodiment, it is more preferable that a beam diameter D₁ of the light beam with which the both main edge regions X, Y of the first solidified portion 24a₁ are irradiated is larger than a beam diameter D₂ of the light beam used when forming the first solidified portion 24a₁ (See FIG. 7). The term “beam diameter (D₁, D₂) of the light beam” as used herein means a diameter at a region of a beam spot having an energy intensity value of 1/e² (i.e., 13.5%) or more of a peak energy intensity value in a case where an energy distribution of the light beam is a Gaussian distribution (see FIG. 7).

The second embodiment is characterized in that the single irradiation region 50B is passed through the first solidified portion 24a₁ such that the single irradiation region 50B covers the entire region of the first solidified portion 24a₁ which has been temporarily formed in the plan view. In this regard, in a case where a width of the first solidified portion 24a₁ and a width of the single irradiation region 50B are substantially the same as each other, both main edge regions X, Y of the first solidified portion 24a₁ may be not positioned in the light beam-irradiation region 50B in a plan view in some cases. In light of the above matters, it is more preferable that the beam diameter D₁ of the light beam with which the both main edge regions X, Y of the first solidified portion 24a₁ are irradiated is larger than the beam diameter D₂ of the light beam used when forming the first solidified portion 24a₁. Thus, it is possible to more suitably position the both main edge regions X, Y of the first solidified portion 24a₁ in the light beam-irradiation region 50B.

According to an embodiment, it is preferable that, as the light beam forming the single irradiation region 50B₁, a light beam whose energy density on both sides portions external to a scanning center line 1 is higher than that on the scanning center line 1 is used (see FIG. 8). The phrase “scanning center line of the light beam” as used herein means a line which is capable of dividing a light beam-irradiation region along a light beam scanning path into two.

As described above, the present invention has such the technical idea that at least both main edge regions X, Y of the first solidified portion 24a₁ are irradiated with the light beam after the formation of the first solidified portion 24a₁. According to this technical idea, the height of the first solidified portion 24a₁ which has been temporarily formed can be reduced. It is a key point that at least both main edge regions X, Y of the first solidified portion 24a₁ which has been temporarily formed are irradiated with the light beam. This means that an irradiation of an intermediate region Z of the first solidified portion 24a₁ with the light beam in a plan view does not particularly contribute to a technical effect of the present invention. Thus, it is preferable to more irradiate both main edge regions X, Y of the first solidified portion 24a₁ with the light beam. In light of the above matters, it is preferable to use the light beam which has the energy density on both sides portions external to the scanning center line 1 higher than that on the scanning center line 1 as the light beam forming the single irradiation region 50B₁. The use of such the light beam makes it possible to prevent an irradiation of the intermediate portion Z of the first solidified portion 24a₁ with the light beam having the higher energy density, a contribution of the irradiation of the intermediate portion Z to the technical effect being not high, i.e., low. Thus, it is possible to increase an irradiation efficiency of the light beam with which both main edge regions X, Y of the first solidified portion 24a₁ are irradiated, which forms the single irradiation region. Specifically, the light beam in the second embodiment can have a configuration in which an energy of the light beam is less likely to be provided to the intermediate portion Z of the first solidified portion 24a₁. Such the configuration enables an energy of the light beam to more intensively and effectively be transferred or supplied to the both main edge regions X, Y of the first solidified portion 24a₁ when using a light beam having a predetermined energy density as a whole. That is, according to this embodiment, the energy of the light beam is positively transferred to regions (i.e., the both main edge regions X, Y of the first solidified portion 24a₁) where the light beam irradiation is particularly necessary, whereas the energy of the light beam is less likely to be transferred to a region where a necessity of the light beam irradiation is not high, i.e., low. This makes it possible to reduce a thermal history (i.e., temperature change) of the first solidified portion 24a₁ during the light beam irradiation, as compared with a case where the energy of the light beam is less likely to be transferred to the region where the necessity of the light beam irradiation is low.

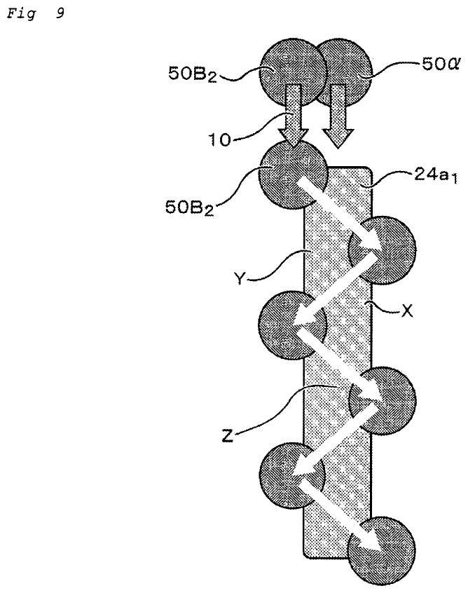

According to an embodiment, it is preferable that a light beam-irradiation is performed such that a single irradiation region 50B₂ is alternately passed through one of the both main edge regions X of the first solidified portion 24a₁ and other of the both main edge regions Y thereof (see FIG. 9).

As described above, in the embodiment wherein the light beam forming the single irradiation region is used, such the single irradiation region is passesd through the first solidified portion 24a₁ to cover the entire region of the first solidified portion 24a₁ which has been temporarily formed in the plan view. In this embodiment, the irradiation of the intermediate portion of the first solidified portion 24a₁ with the light beam in the plan view does not contribute so much to the technical effect of the present invention. Thus, it is desirable to more suitably irradiate the both main edge regions X, Y of the first solidified portion 24a₁ with the light beam. In light of the above matters, according to an embodiment, it is preferable that the light beam-irradiation is performed such that the single irradiation region 50B₂ is alternately passed through one of the both main edge regions X of the first solidified portion 24a₁ and other of the both main edge regions Y thereof. In such the embodiment, a passing of the single irradiation region 50B₂ in a zigzag manner, instead of two irradiation regions, makes it possible to suitably transfer or supply an energy of the light beam to the both main beam portions X, Y of the first solidified portion 24a₁. In the case of the passing of the single irradiation region 50B₂ in the zigzag manner, the energy of the light beam can be intensively transferred to regions (i.e., the both main edge regions X, Y of the first solidified portion 24a₁) where the light beam irradiation is particularly necessary. While on the other hand, due to the passing of the single irradiation region 50B₂ in the zigzag manner, the energy of the light beam is less likely to be transferred to a region where a necessity of the light beam irradiation is not high, i.e., low. This makes it possible to reduce an irradiation of the region where the necessity of the light beam irradiation is low (i.e., intermediate region Z of the first solidification portion 24a₁) with a light beam having a high energy density.

According to an embodiment, it is preferable that a position of an irradiation region of the light beam which is used when forming the first solidified portion is shifted for each solidified layer. The shift arrangement makes it possible to suitably avoid that light beams each of which has a relatively higher energy density are aligned with each other in a z-axis direction. Thus, it is possible to avoid that a shrinkage stress of each first solidified portion, which causes a warp of a shaped object, may occur such that occurrence positions of shrinkage stress are aligned in the z-axis direction. The avoidance makes it possible to improve a strength of a shaped object to be finally obtained as a whole.

In the first and second irradiation embodiments, at least both main edge regions of the first solidified portion maybe irradiated with the light beam shortly subsequent to the formation of the first solidified portion. The phrase “irradiation of at least both main edge regions of the first solidified portion with the light beam shortly subsequent to the formation of the first solidified portion” as used herein means that at least both of the one and the other of the main edge regions are irradiated with the light beam immediately after the formation of the first solidified portion. As described above, the embodiment wherein at least the other of the main edge regions is irradiated with the light beam may include an embodiment wherein the other of the main edge regions of the first solidified portion is irradiated with the light beam after a light beam-irradiation has been performed along each of scanning paths such that the scanning paths have a parallel configuration in a direction (e.g., after a formation of a fourth solidified portion, a fifth solidified portion, a sixth solidified portion and the like). Without being limited to this, in order to reduce a height of the first solidified portion which has been temporarily formed at an early point in time, at least not only the one of main edge regions of the first solidified portion but also the other of main edge regions thereof may be irradiated with the light beam immediately after the first solidified portion has been temporarily formed. Due to the reduction in the height of the first solidified portion which has been temporarily formed at the early point in time, even if there is necessary to form a new further powder layer earlier than usual, such the earlier formation of the new further powder layer is possible.

### EXAMPLES

Examples as to an embodiment of the present invention will be described below. It should be noted that the examples do not directly reflect whole embodiments for embodying the technical idea of the present invention, but are merely an introduction of the above first irradiation embodiment as an example of the irradiation embodiment for embodying the technical idea of the present invention. This is because irradiation embodiments for embodying the technical idea of the present invention can include the above second irradiation embodiment as well as the above first irradiation embodiment.

### Comparative Example

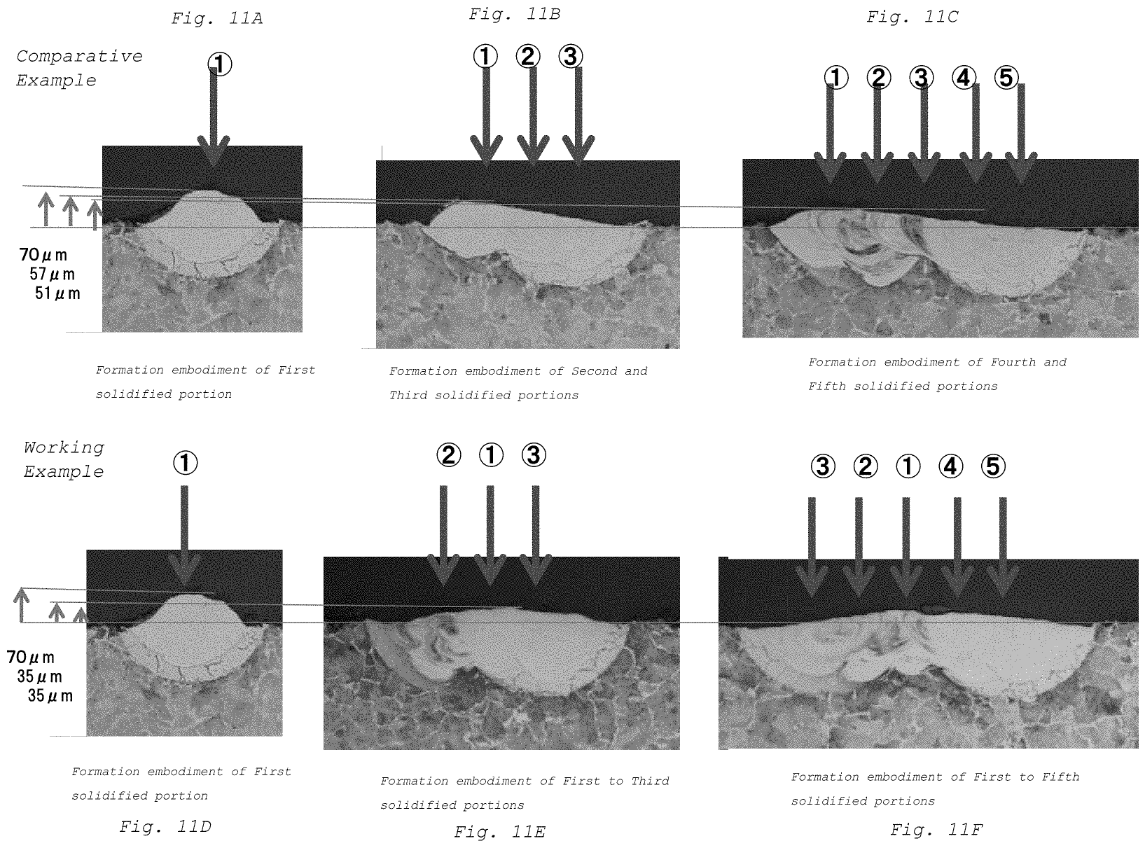

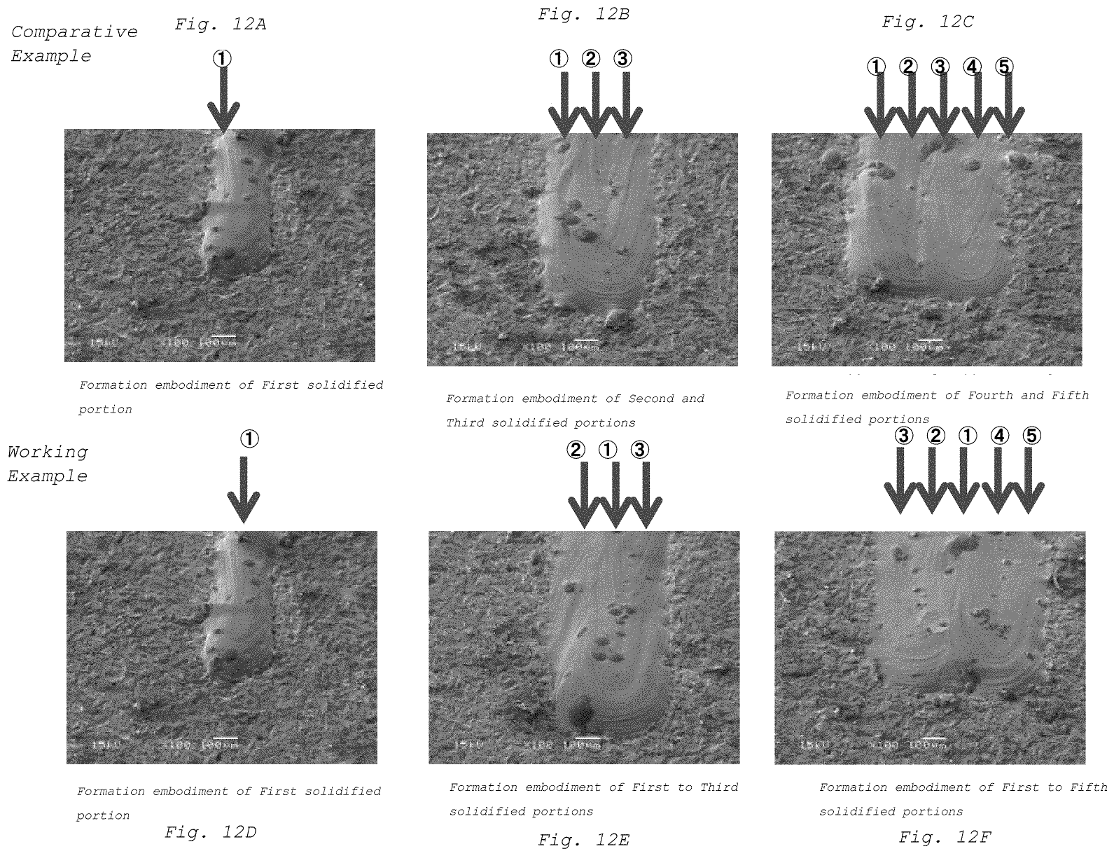

A comparative example will be described below. This comparative example is an example in accordance with “conventional technical common knowledge of the skilled person” (see left side portion of FIG. 4, FIG. 5A, FIGS. 11A to 11C, and FIGS. 12A to 12C).

A new solidified layer (i.e., single solidified layer) was formed via the following steps.

(1)′ A step of forming a new powder layer 22′ using a squeezing blade on an already formed solidified layer 24′ or on a base plate which serves as a base
(2)′ A step of irradiating a predetermined portion of the new powder layer 22′ with a light beam along a first scanning path 10′ after the formation of the new powder layer 22′, thereby to form a first solidified portion 24a₁′
(3)′ A step of irradiating one of main edge regions X′ of the first solidified portion 24a₁′ and a non-irradiated region with the light beam along a second scanning path 10′ after the formation of the first solidified portion 24a₁′, thereby to form a second solidified portion 24b′ overlapping a first solidified portion 24a₂′, the non-irradiated region being adjacent to the one of the main edge regions X′
(4)′ A step of irradiating one of main edge regions X′ of the second solidified portion 24b′, and a non-irradiated region with the light beam along a third scanning path 10′ after the formation of the second solidified portion 24b′, thereby to form a third solidified portion overlapping a second solidified portion 24b′, the non-irradiated region being adjacent to the one of the main edge regions X′
(5)′ A step of irradiating one of main edge regions X′ of the third solidified portion and a non-irradiated region with the light beam along a fourth scanning path 10′ after the formation of the third solidified portion, thereby to form a fourth solidified portion, the non-irradiated region being adjacent to the one of the main edge regions X′
(6)′ A step of irradiating one of main edge regions X′ of the fourth solidified portion and a non-irradiated region with the light beam along a fifth scanning path 10′ after the formation of the fourth solidified portion, thereby to form a fifth solidified portion, the non-irradiated region being adjacent to the one of the main edge regions X′

In this comparative example, a height of the new powder layer 22′ obtained by performing the step (1)′ was 50 μm. Furthermore, a height of a zenith region of the first solidified portion 24a₁′ obtained by performing the step (2)′ was 70 μm. An imaging of the solidified portion (for example, the first solidified portion 24a₁′) was performed by the following process. Specifically, a test piece solidified with laser (i.e., solidified portion) was embedded with epoxy resin, a cross section of the test piece perpendicular to a laser scanning axis direction was exposed by a polishing process, and subsequently an imaging of the exposed cross section was performed by an optical microscope, thereby performing the imaging of the solidified portion. Also, the height of the zenith region of the solidified portion was measured by the following process. Specifically, the height of the zenith region of solidified portion was measured by measuring a distance from a surface of the base portion (e.g., a solidified layer located immediately below the test piece) to a vertex of the solidified portion using a length measuring microscope.

As described above, in the step (3)′ of this comparative example, one of main edge regions X′ of the first solidified portion 24a₁′ having the height of the zenith region of 70 μm and the non-irradiated region were irradiated with the light beam. Namely, the light beam irradiation was performed such that a light beam-irradiation region could be passed through the one of main edge regions X′ as well as the non-irradiated region 60X′ by a light beam-movement along the scanning path.

The light beam-irradiation caused an irradiation heat of the light beam to be transferred to the one of main edge regions X′ which has been temporarily in the solidified state as well as powders at the non-irradiated region 60X′, which caused them to be in a melted state. In the melted state, a melted portion of the one of main edge regions X′ and a melted portion of the powders at the non-irradiated region 60X′ were mixed with each other. Then, due to a cooling of the mixed melted portions and subsequent solidification, it was possible to obtain the second solidified portion 24b′ overlapping with only the one of main edge regions X′ of the first solidified portion. In this comparative example, due to the irradiation of only the one of main edge regions X′ of the first solidified portion 24a₁′ which has been temporarily in the solidified state, a zenith region of a first solidified portion 24a₂′ newly formed, at a point in time when the formation of the second solidified portion 24b′ was completed, had a slightly reduced height of 57 μm, compared with the first solidified portion 24a₁′ having the zenith region with its height of 70 μm.

After the formation of the second solidified portion 24b′, the step (4)′ was performed to irradiate the one of main edge regions X′ of the second solidified portion 24b′ and the non-irradiated region with the light beam, thereby to form the third solidified portion overlapping the second solidified portion 24b′, the non-irradiated region being adjacent to the one of the main edge regions X′. After the formation of the third solidified portion, the step (5)′ was performed to irradiate the one of main edge regions X′ of the third solidified portion and the non-irradiated region with the light beam, thereby to form the fourth solidified portion overlapping the third solidified portion, the non-irradiated region being adjacent to the one of the main edge regions X′. After the formation of the fourth solidified portion in the step (5)′, the step (6)′ was further performed to form the fifth solidified portion. Thus, it was possible to form a new solidified layer composed of a plurality of the solidified portions (i.e., the first solidified portion firstly formed to the fifth solidified portion fifthly formed). At a point in time when the formation of the fifth solidified portion was completed, a zenith region of a first solidified portion 24a₂′ newly formed had a slightly reduced height of 51 μm.

In light of the above matters, by performing the steps (2)′ to (6)′, the first solidified portion to the fifth solidified portion were configured such that a portion of each solidified portion overlapped with each other and also such that the first solidified portion to the fifth solidified portion had a sequence arrangement in a single direction. The above configuration of the first solidified portion to the fifth solidified portion was based on the conventional technical common knowledge of the skilled person.

After the formation of the new solidified layer 24′, a formation of a further new powder layer was performed using a horizontally movable squeegee blade. In this comparative example, a lower end of the squeegee blade was however located below the zenith region of the first solidified portion 24a₂′. In other words, the first solidified portion 24a₂′ was located above the lower end of the horizontally movable squeegee blade for the formation of the further new powder layer, the first solidified portion 24a₂′ being obtained by the melting and subsequent solidification of the one of main edge regions X′ of the first solidified portion 24a₁′. Thus, the squeegee blade came into contact with the first solidified portion 24a₂′, and thus it was not possible to suitably form the further new powder layer using the horizontally movable squeegee blade.

### Working Examples

Working examples on an embodiment of the present invention will be described below. The working examples are different from an embodiment in accordance with the conventional technical common knowledge of the skilled person (see FIGS. 2 to 3, right side portion of FIG. 4, FIG. 5B, FIGS. 11D to 11E, and FIGS. 12D to 12E).

### Working Example 1

A new solidified layer (i.e., single solidified layer) composed of three solidified portions was formed via the following steps.

(1) A step of forming a new powder layer 22 using a squeezing blade on an already formed solidified layer 24 or on a base plate which serves as a base
(2) A step of irradiating a predetermined portion of the new powder layer 22 with a light beam along a first scanning path 10 after the formation of the new powder layer 22, thereby to form a first solidified portion 24a₁
(3) A step of irradiating one of main edge regions X of the first solidified portion 24a₁ and a non-irradiated region 60 with the light beam along a second scanning path 10 after the formation of the first solidified portion 24a₁, thereby to form a second solidified portion 24b, the non-irradiated region 60 being adjacent to the one of the main edge regions X
(4) A step of irradiating other of main edge regions Y of the first solidified portion 24a₁ and a non-irradiated region 60 with the light beam along a third scanning path 10 at the substantially same timing as that of the above step (3), thereby to form a third solidified portion 24c, the non-irradiated region 60 being adjacent to the other of the main edge regions Y

By performing the above steps, the new solidified layer 24 composed of three solidified portions (i.e., the first solidified portion firstly formed to the third solidified portion thirdly formed) was formed. In this working example 1, a height of the new powder layer 22 obtained by performing the step (1) was 50 μm. Furthermore, a height of a zenith region of the first solidified portion 24a₁ obtained by performing the step (2) was 70 μm. An imaging of the solidified portion (for example, the first solidified portion 24a₁) was performed by the following process. Specifically, a test piece solidified with laser (i.e., solidified portion) was embedded with epoxy resin, across section of the test piece perpendicular to a laser scanning axis direction was exposed by a polishing process, and subsequently an imaging of the exposed cross section was performed by an optical microscope, thereby performing the imaging of the solidified portion. Also, the height of the zenith region of the solidified portion was measured by the following process. Specifically, the height of the zenith region of solidified portion was measured by measuring a distance from a surface of the base portion (e.g., a solidified layer located immediately below the test piece) to a vertex of the solidified portion using a length measuring microscope.

As described above, in the step (3) of this working example, the one of main edge regions X of the first solidified portion 24a₁ having the height of the zenith region of 70 μm and the non-irradiated region 60 were irradiated with the light beam L, the non-irradiated region 60 being adjacent to the one of the main edge regions X. In addition to the step (3), in the step (4) of this working example, teh other of main edge regions Y of the first solidified portion 24a₁ and the non-irradiated region 60 were irradiated with the light beam L, the non-irradiated region 60 being adjacent to the other of the main edge regions Y. Namely, the both main edge regions X, Y and the non-irradiated regions 60 are respectively irradiated with the light beam L, the non-irradiated regions 60 being respectively adjacent to the both main edge regions X, Y of the first solidified portion 24a₁.

Specifically, in the step (3) of this working example, the light beam L irradiation was performed such that a light beam-irradiation region 50A₁ could be passed through the one of main edge regions X of the first solidified portion 24a₁ as well as the non-irradiated region 60X of the light beam L by a light beam L-movement along the scanning path. In addition to the step (3), in the step (4) of this working example, the light beam L irradiation was performed such that a light beam-irradiation region 50A₂ could be passed through the other of main edge regions Y of the first solidified portion 24a₁ as well as the non-irradiated region 60Y of the light beam L by a light beam L-movement along the scanning path.

The light beam L irradiation in the step (3) enabled the one of main edge regions X of the first solidified portion 24a₁ as well as the non-irradiated region 60X of the light beam L to be positioned in the light beam-irradiation region 50A₁. Thus, such the light beam L irradiation enabled an irradiation heat of the light beam L to be transferred to the one of main edge regions X which has been temporarily in the solidified state as well as powders 19 at the non-irradiated region 60X, which enabled both of them to be in a melted state. Similarly, the light beam L irradiation in the step (4) enabled the other of main edge regions Y of the first solidified portion 24a₁ as well as the non-irradiated region 60Y of the light beam L to be positioned in the light beam-irradiation region 50A₂. Thus, such the light beam L irradiation enabled an irradiation heat of the light beam L to be transferred to the other of main edge regions Y which has been temporarily in the solidified state as well as powders 19 at the non-irradiated region 60Y, which enabled both of them to be in a melted state.

When the one of the main edge regions X was changed from the solidified state to the melted state in the step (3), due to the fact that the melted one of the main edge regions X had a fluidity and the first solidified portion 24a₁ had an inclined cross sectional surface, at least a part of the melted one of the main edge regions X flowed outwardly. This caused at least a part of melted portion of the one of the main edge regions X flowing ourwardly and a melted portion of the powders 19 in the non-irradiated region 60X to be mixed with each other. Similarly, when the other of the main edge regions Y was changed from the solidified state to the melted state in the step (4), due to the fact that the melted other of the main edge regions Y had a fluidity and the first solidified portion 24a₁ had an inclined cross sectional surface, at least a part of the melted other of the main edge regions Y flowed outwardly. This caused at least a part of melted portion of the other of the main edge regions Y flowing ourwardly and a melted portion of the powders 19 in the non-irradiated region 60Y to be mixed with each other.

According to the working example 1, due to each outward flow for not only the melted portion of the one of the main edge regions X but also the melted portion of the other of the main edge regions Y, it was possible to further reduce a height of a first solidified portion 24a₂ newly obtained by a re-solidification of the melted portions in the mixed state on each main edge region side (see right side portion of FIG. 4 and FIG. 5B). Specifically, a height of a zenith region of the first solidified portion 24a₂, which was newly obtained by performing the steps (3) and (4), was 35 μm.

Furthermore, due to a cooling of the melted portions in the mixed state and subsequent solidification on each of side regions of the first solidified portion 24a₁, it was possible to form the second solidified portion 24b overlapping with the one of main edge regions X of the first solidified portion. In addition to the formation of the second solidified portion 24b, it was also possible to form the third solidified portion 24c overlapping with the other of main edge regions Y of the first solidified portion. Namely, the working example 1 made possible to the new solidified portions (i.e., the second and third solidified portions 24b, 24c) on the both main edge regions X, Y of the first solidified portion 24a₂.

After finally forming the new solidified layer 24, a formation of a further new powder layer was performed using a horizontally movable squeegee blade. In this working example 1, a lower end of the squeegee blade was located above the zenith region of the first solidified portion 24a₂ obtained by the melting and subsequent solidification of the both main edge regions X, Y of the first solidified portion 24a₁. In other words, the first solidified portion 24a₂ was located below the lower end of the horizontally movable squeegee blade for the formation of the further new powder layer. Thus, it was possible to avoid a contact of the squeegee blade with the first solidified portion 24a₂, and thus it was possible to suitably form the further new powder layer using the horizontally movable squeegee blade.

### Working Example 2

A new solidified layer (i.e., single solidified layer) composed of five solidified portions was formed via the following steps.

(1) A step of forming a new powder layer 22 using a squeezing blade on an already formed solidified layer 24 or on a base plate which serves as a base
(2) A step of irradiating a predetermined portion of the new powder layer 22 with a light beam along a first scanning path 10 after the formation of the new powder layer 22, thereby to form a first solidified portion 24a₁
(3) A step of irradiating one of main edge regions X of the first solidified portion 24a₁ and a non-irradiated region 60 with the light beam along a second scanning path 10 after the formation of the first solidified portion 24a₁, thereby to form a second solidified portion 24b, the non-irradiated region 60 being adjacent to the one of the main edge regions X of the first solidified portion 24a₁
(4) A step of irradiating one of main edge regions of the second solidified portion 24b and a non-irradiated region with the light beam along a third scanning path 10 after the formation of the second solidified portion 24b, thereby to form a third solidified portion, the non-irradiated region being adjacent to the one of the main edge regions of the second solidified portion 24b
(5) A step of irradiating other of main edge regions Y of the first solidified portion 24a₁
and a non-irradiated region with the light beam along a fourth scanning path 10 after the formation of the third solidified portion, thereby to form a fourth solidified portion, the non-irradiated region being adjacent to the other of the main edge regions Y of the first solidified portion 24a₁
(6) A step of irradiating one of main edge regions of the fourth solidified portion and a non-irradiated region with the light beam along a fifth scanning path 10 after the formation of the fourth solidified portion, thereby to form a fifth solidified portion, the non-irradiated region being adjacent to the one of the main edge regions of the fourth solidified portion

By performing the above steps, the new solidified layer 24 composed of five solidified portions (i.e., the first solidified portion firstly formed to the fifth solidified portion fifthly formed) was formed. In this working example 2, a height of the new powder layer 22 obtained by performing the step (1) was 50 μm. Furthermore, a height of a zenith region of the first solidified portion 24a₁ obtained by performing the step (2) was 70 μm. An imaging of the solidified portion (for example, the first solidified portion 24a₁) was performed by the following process. Specifically, a test piece solidified with laser (i.e., solidified portion) was embedded with epoxy resin, across section of the test piece perpendicular to a laser scanning axis direction was exposed by a polishing process, and subsequently an imaging of the exposed cross section was performed by an optical microscope, thereby performing the imaging of the solidified portion. Also, the height of the zenith region of the solidified portion was measured by the following process. Specifically, the height of the zenith region of solidified portion was measured by measuring a distance from a surface of the base portion (e.g., a solidified layer located immediately below the test piece) to a vertex of the solidified portion using a length measuring microscope.

According to the working example 2 as described above, the one of main edge regions X of the first solidified portion 24a₁ having the height of the zenith region of 70 μm and the non-irradiated region 60 was irradiated with the light beam L in the step (3), the non-irradiated region 60 being adjacent to the one of the main edge regions X. In addition to the step (3), in the step (5) of this working example 2, the other of main edge regions Y of the first solidified portion 24a₁ and the non-irradiated region 60 were irradiated with the light beam L, the non-irradiated region 60 being adjacent to the other of the main edge regions Y. Namely, the both main edge regions X, Y and the non-irradiated regions 60 are respectively irradiated with the light beam L, the non-irradiated regions 60 being respectively adjacent to the both main edge regions X, Y of the first solidified portion 24a₁.

Specifically, in the step (3) of the working example 2, the light beam L irradiation was performed such that a light beam-irradiation region could be passed through the one of main edge regions X of the first solidified portion 24a₁ as well as the non-irradiated region of the light beam L by a light beam L-movement along the scanning path. In addition to the step (3), in the step (5) of the working example 2, the light beam L irradiation was performed such that a light beam-irradiation region could be passed through the other of main edge regions Y of the first solidified portion 24a₁ as well as the non-irradiated region of the light beam L by a light beam L-movement along the scanning path.

The light beam L irradiation in the step (3) enabled the one of main edge regions X of the first solidified portion 24a₁ as well as the non-irradiated region 60X of the light beam L to be positioned in the light beam-irradiation region. Thus, such the light beam L irradiation enabled an irradiation heat of the light beam L to be transferred to the one of main edge regions X which has been temporarily in the solidified state as well as powders 19 at the non-irradiated region, which enabled both of them to be in a melted state. Similarly, the light beam L irradiation in the step (5) enabled the other of main edge regions Y of the first solidified portion 24a₁ as well as the non-irradiated region 60Y of the light beam L to be positioned in the light beam-irradiation region. Thus, such the light beam L irradiation enabled an irradiation heat of the light beam L to be transferred to the other of main edge regions Y which has been temporarily in the solidified state as well as powders 19 at the non-irradiated region 60Y, which enabled both of them to be in a melted state.

When the one of the main edge regions X was changed from the solidified state to the melted state in the step (3), due to the fact that the melted one of the main edge regions X had a fluidity and the first solidified portion 24a₁ had an inclined cross sectional surface, at least a part of the melted one of the main edge regions X flowed outwardly. This caused at least a part of melted portion of the one of the main edge regions X flowing ourwardly and a melted portion of the powders 19 in the non-irradiated region to be mixed with each other. Similarly, when the other of the main edge regions Y was changed from the solidified state to the melted state in the step (5), due to the fact that the melted other of the main edge regions Y had a fluidity and the first solidified portion 24a₁ had an inclined cross sectional surface, at least a part of the melted other of the main edge regions Y flowed outwardly. This caused at least a part of melted portion of the other of the main edge regions Y flowing ourwardly and a melted portion of the powders 19 in the non-irradiated region to be mixed with each other.

According to the working example 2, due to each outward flow for not only the melted portion of the one of the main edge regions X but also the melted portion of the other of the main edge regions Y, it was possible to further reduce a height of a first solidified portion 24a₂ newly obtained by a re-solidification of the melted portions in the mixed state on each main edge region side. Specifically, a height of a zenith region of the first solidified portion 24a₂, which was newly obtained by performing the steps (3) and (5), was 35 μm. Furthermore, according to the working example 2, it was possible to form the second solidified portion and the third solidified portion, each of which overlapping with each other on the one of main edge regions X side of the first solidified portion. In addition to the formation of the second and third solidified portions, according to the working example 2, it was possible to form the fourth solidified portion and the fifth solidified portion, each of which overlapping with each other on the other of main edge regions Y side of the first solidified portion.

After finally forming the new solidified layer 24, a formation of a further new powder layer was performed using a horizontally movable squeegee blade. In this working example 2, a lower end of the squeegee blade was located above the zenith region of the first solidified portion 24a₂ obtained by the melting and subsequent solidification of the both main edge regions X, Y of the first solidified portion 24a₁. In other words, the first solidified portion 24a₂ was located below the lower end of the horizontally movable squeegee blade for the formation of the further new powder layer. Thus, it was possible to avoid a contact of the squeegee blade with the first solidified portion 24a₂, and thus it was possible to suitably form the further new powder layer using the horizontally movable squeegee blade.

As described above, by performing each step according to the working example 2 forming five solidified portions, it was possible to form the second solidified portion and the third solidified portion partially overlapping with the second solidified portion on the one of side regions of the first solidified portion. Also, it was possible to form the fourth solidified portion and the fifth solidified portion partially overlapping with the fourth solidified portion on the other of side regions of the first solidified portion. In this regard, if a new solidified portion can be formed by irradiating the other of main edge regions Y-side of the first solidified portion 24a₁ with the light beam at any timing, the embodiment for forming the new solidified portion is not limited to the process in accordance with the working example 2. For example, after forming a second solidified portion and a third solidified portion respectively on both sides of a first solidified portion, a fourth solidified portion partially overlapping with the second solidified portion and a fifth solidified portion partially overlapping with the fourth solidified portion may be formed. According to another embodiment, for example, a second solidified portion may be formed on one of side regions of a first solidified portion, a third solidified portion partially overlapping with the second solidified portion may be formed, a fourth solidified portion partially overlapping with the third solidified portion may be formed, and subsequently a fifth solidified portion may be formed on other of side regions of the first solidified portion.

Although some embodiments of the present invention have been hereinbefore described, these are merely typical examples in the scope of the present invention. Accordingly, the present invention is not limited to the above embodiments. It will be readily appreciated by the skilled person that various modifications are possible without departing from the scope of the present invention.

As described in the above first irradiation embodiment, it is preferable that the light beam used upon the formation of the second and subsequent solidified portions has the energy density relatively lower than that of the light beam used upon the formation of the first solidified portion. If the light beam having the relatively larger energy density is used for the formation of only the first solidified portion 24a₁ which has been temporarily formed, the use of the light beam having the relatively lower energy density is possible in not only the first irradiation embodiment but also the second irradiation embodiment. Namely, the use of the light beam having the relatively lower energy density is also possible in the embodiment wherein the single irradiation region 50B is passesd through the first solidified portion 24a₁ to cover the entire region of the first solidified portion 24a₁ which has been temporarily formed in the plan view. The second irradiation embodiment is an embodiment wherein the entire area including both main edge regions X, Y of the first solidified portion 24a₁ is irradiated with the light beam along the axial direction of the first solidified portion 24a₁ which has been temporarily formed, followed by being melted and subsequently solidified, thereby to form the first solidified portion 24a₂ having the more reduced height. When the entire area including both main edge regions X, Y of the first solidified portion 24a₁ which has been temporarily formed is irradiated with the light beam having the relatively larger energy density, a relatively larger shrinkage stress may occur not only “upon the temporary formation of the first solidified portion 24a₁” but also” upon the formation of the first solidified portion 24a₂ having the more reduced height”. As a result, the occurrence of the relatively larger shrinkage stress may cause a formation of the first solidified portion 24a₂ having a relatively larger shrinkage stress as a whole.

In light of the above matters, it is preferable to use a light beam having a relatively larger energy density upon the temporary formation of the first solidified portion 24a₁, whereas, it is preferable to use a light beam having a relatively lower energy density upon the formation of the first solidified portion 24a₂ having a more reduced height. Namely, the light beam having the relatively larger energy density is used for only the temporary formation of the first solidified portion 24a₁. Thus, it is possible to form the first solidified portion 24a₂ having a relatively lower shrinkage stress and the more reduced height as a whole, compared with a case where the light beam having the relatively larger energy density is used for not only “for the temporary formation of the first solidified portion 24a₁” but also “for the formation of the first solidified portion 24a₂ having the more reduced height”. The relatively lower shrinkage stress of the first solidified portion 24a₂ enables a reduction of a warpage of the new solidified layer including such the first solidified portion 24a₂, which makes it possible to suitably prevent an occurence of a warpage of a three-dimensional shaped object to be finally obtained.

Furthermore, as described in the above second irradiation embodiment, it is more preferable that the beam diameter D₁ of the light beam with which the whole area including the both main edge regions X, Y of the first solidified portion 24a₁ is irradiated is larger than the beam diameter D₂ of the light beam used upon the temporary formation of the first solidified portion 24a₁ (see FIG. 7). Thus, it is possible to more suitably position the both main edge regions X, Y of the first solidified portion 24a₁ which has been temporarily formed in the light beam-irradiation region. A light beam having an adjusted beam diameter can use in not only the second irradiation embodiment but also the first irradiation embodiment. Thus, upon the light beam-irradiation of the one of the main edge regions X of the first solidified portion 24a₁ as well as the non-irradiated region 60X in accordance with the first irradiation embodiment, the first solidified portion 24a₁ being a solidified portion temporarily formed and the non-irradiated region 60X being adjacent to the one of the main edge regions X, the use of the light beam having the relatively larger beam diameter D₁ makes it possible to more suitably irradiate the one of main edge regions X of the first solidified portion 24a₁. Furthermore, upon the light beam-irradiation of the other of the main edge regions Y of the first solidified portion 24a₁ as well as the non-irradiated region 60Y in accordance with the first irradiation embodiment, the first solidified portion 24a₁ being a solidified portion temporarily formed and the non-irradiated region 60Y being adjacent to the other of the main edge regions Y, the use of the light beam having the relatively larger beam diameter D₁ makes it possible to more suitably irradiate the other of main edge regions Y of the first solidified portion 24a₁.

### INDUSTRIAL APPLICABILITY

The manufacturing method according to an embodiment of the present invention can provide various kinds of articles. For example, in a case where the powder layer is a metal powder layer (i.e., an inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., an organic powder layer) and thus the solidified layer corresponds to a cured layer, the three-dimensional shaped object obtained by an embodiment of the present invention can be used as a resin molded product.

### CROSS REFERENCE TO RELATED PATENT APPLICATION

The present application claims the right of priority of Japanese Patent Application No. 2018-014903 (filed on Jan. 31, 2018, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

X One of both main edge regions of first solidified portion
X′ (Conventional) One of both main edge regions of first solidified portion
Y Other of both main edge regions of first solidified portion
Z Intermediate region of first solidified portion
10′ scanning path
10′ (Conventional) Scanning path
19 Powder
19′ (Conventional) Powder
22 Powder layer
22′ (Conventional) Powder layer
23′ (Conventional) Squeezing blade
24 Solidified layer
24′ (Conventional) Solidified layer
24a₁ First solidified portion temporarily formed
24a₂ First solidified portion finally formed
24b Second solidified portion
24c Third solidified portion
24a′ (Conventional) first solidified portion
24a Virtual contour
24a₁′ (Conventional) first solidified portion
24a₂′ (Conventional) first solidified portion
24b′ (Conventional) second solidified portion
24n-1′ n-1th formed solidified portion
24n′ nth formed solidified portion
50, 50A₁, 50A₂, 50α, 50B, 50B₁, 50B₂ Light beam-irradiation region
50′ (Conventional) Light beam-irradiation region
60, 60X, 60Y Non-irradiated region of Light beam
L Light beam
l( [symbol] ) Scanning center line of Light beam
l( [symbol] )₂ Scanning center line of Light beam with which one of main edge regions of first solidified portion is irradiated
l( [symbol] )₁ Scanning center line of Light beam used upon formation of first solidified portion
D₁, D₂ Beam diameter of Light beam

1.-17. (canceled)

18. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by newly forming a powder layer on the formed solidified layer, followed by an irradiation of a predetermined portion of the newly formed powder layer with the light beam,
wherein the solidified layer composed of a plurality of solidified portions is formed, the plurality of the solidified portions overlapping with each other, and
wherein, after a formation of a first solidified portion as a solidified portion which is firstly formed, at least both main edge regions of the first solidified portion are irradiated with the light beam such that the at least both main edge regions of the first solidified portion are melted.

19. The method according to claim 18, wherein, after the formation of the first solidified portion, an irradiation with the light beam is performed such that an irradiation region of the light beam is passed through the at least both main edge regions of the first solidified portion.

20. The method according to claim 18, wherein, after the formation of the first solidified portion,
the at least both main edge regions of the first solidified portion and non-irradiated regions of the light beam are irradiated with the light beam, the non-irradiated regions being respectively adjacent to the both main edge regions.

21. The method according to claim 20, wherein, after the formation of the first solidified portion, a second solidified portion and a third solidified portion are respectively formed on both sides of the first solidified portion by irradiating the both main edge regions of the first solidified portion and the non-irradiated regions which are respectively adjacent to the both main edge regions with the light beam, each of the second solidified portion and the third solidified portion overlapping with the first solidified portion.

22. The method according to claim 18, wherein an energy density of the light beam with which the at least both main edge regions of the first solidified portion are irradiated after the formation of the first solidified portion is smaller than that of the light beam used when forming the first solidified portion.

23. The method according to claim 18, wherein a beam diameter of the light beam with which the at least both main edge regions of the first solidified portion are irradiated after the formation of the first solidified portion is larger than that of the light beam used when forming the first solidified portion.

24. The method according to claim 18, wherein the at least both main edge regions of the first solidified portion are irradiated with the light beam shortly subsequent to the formation of the first solidified portion.

25. The method according to claim 18, wherein an irradiation with the light beam is performed such that two irradiation regions are respectively passed through the at least both main edge regions of the first solidified portion.

26. The method according to claim 25, wherein two irradiation regions are respectively passed through the at least both main edge regions of the first solidified portion, in parallel temporally.

27. The method according to claim 25, wherein a scanning center line of the light beam with which one of the main edge regions of the first solidified portion is irradiated after the formation of the first solidified portion is located at a portion proximal to a virtual contour to be a contour of the solidified layer, than a scanning center line of the light beam used when forming the first solidified portion.

28. The method according to claim 18, wherein, after the formation of the first solidified portion, the irradiation with the light beam is performed such that a single irradiation region is passed through the at least both main edge regions of the first solidified portion in an axial direction of the first solidified portion.

29. The method according to claim 28, wherein the irradiation with the light beam is performed such that the single irradiation region is alternately passed through one of the both main edge regions and other of the both main edge regions.

30. The method according to claim 28, wherein, as the light beam forming the single irradiation region, a light beam whose energy density on both sides portions external to a scanning center line is higher than that on the scanning center line is used.

31. The method according to claim 18, wherein a position of the irradiation region of the light beam used when forming the first solidified portion is shifted for each solidified layer.

32. The method according to claim 18, wherein the first solidified portion is formed by the irradiation with the light beam along a first scanning path, and both side portions external to an irradiation region which is formed by the irradiation with the light beam are non-irradiated portions of the light beam, the both side portions being adjacent to the irradiation region.

33. The method according to claim 18, wherein a first solidified portion obtained by a melting and subsequent solidification of the at least both main edge regions of the first solidified portion is located below a lower end of a horizontally movable squeezing blade to be used for forming the powder layer later.
